(19) United States
(12) Patent Application Publication
(10) Pub. No.: US 2013/0326324 A1
(43) Pub. Date: Dec. 5, 2013

(54) DOCUMENT MANAGEMENT SERVER, DOCUMENT MANAGEMENT METHOD, AND STORAGE MEDIUM

(71) Applicant: CANON KABUSHIKI KAISHA, Tokyo (JP)

(72) Inventor: Tamaki Kamata, Yokohama-shi (JP)

(73) Assignee: CANON KABUSHIKI KAISHA, Tokyo (JP)

(21) Appl. No.: 13/903,796

(22) Filed: May 28, 2013

(30) Foreign Application Priority Data
May 31, 2012 (JP) 2012-124832

(51) Int. Cl. G06F 17/22

(52) U.S. Cl. CPC G06F 17/2288
USPC 715/229

(57) ABSTRACT

A document management server, in a case where a document of the same name as that of a document being requested to be registered from a client has been registered, determines whether the document of the same name has a plurality of versions. If the document management server determines that the document of the same name has a plurality of versions, after the document name of the document of the same name has been changed, the document management server registers the document being requested to be registered. Meanwhile, if the document management server determines that the document of the same name has only one version, the document management server overwrites the document being requested to be registered with the document of the same name, and registers the overwritten document.

### BACKGROUND OF THE INVENTION

1. Field of the Invention

The present invention relates to a document management system having a document version management function.

2. Description of the Related Art

A function for managing versions of a document (file) is provided in many document management systems (also referred to as file management systems, or document sharing systems). In such document management systems, while, at the document management server side, the function of managing versions of each document is to be provided, at the client side, a function of operating each document by specifying a version needs to be provided.

For example, a client apparatus can handle a version-managed document without problem by accessing a document managed by a document management server using a dedicated client application complying with the version management function. If the client apparatus is provided with a web browser, the apparatus can handle the version-managed document without problem by accessing the document via a web site of the document management server being configured to comply with the version management function.

Japanese Patent Application Laid-Open No. 5-181723 discusses a technique to give a plurality of file names to one file entity according to naming rules of a plurality of applications in a case where the file is shared in the applications having different rules for naming the number of versions of a file.

Meanwhile, various Web Distributed Authoring and Versioning (WebDAV) client applications (hereinafter, referred to as a WebDAV client) employing the HTTP 1.1 extension WebDAV protocol have been increasingly used. If a document management server is compliant with the WebDAV, the server can access the document management server using these WebDAV clients. Such a WebDAV-compliant document management system can operate a document in the document management server by using the WebDAV client without developing a dedicated client application. However, many existing WebDAV clients are not compliant with the version management function (are not provided with the function to specify a version to operate a document).

When such a WebDAV client not compliant with the version management function accesses the document management server, no version of the document to be operated is specified. As a result, when the WebDAV client tries to overwrite the existing document in the document management server, even if the versions of the existing document in the document management server are being managed, all versions of the existing document are considered to be operation targets, and the document is deleted and replaced with a document sent from the WebDAV client.

To solve the problem, the document management server can be configured, when an overwrite instruction of the document is sent from the WebDAV client, to always add and register the document as a new different version to prevent the deletion of the versions of the existing document. If the document management server is configured to add and register the document that has been instructed to be overwritten every time, regardless of the importance of the existing document in the server, every time the WebDAV client issues the overwrite instruction, versions of the existing document increase without limit. This increases the data amount of the stored documents, and may cause server storage shortage.

### SUMMARY OF THE INVENTION

The present invention is directed to a document management system.

According to an aspect of the present invention, a document management server having a document version management function is provided. The document management server includes a reception unit configured to receive a registration request of a document from a client, a first determination unit configured to, in a case where a document of the same name as that of the document being requested to be registered has been registered, determine whether the document of the same name has a plurality of versions, a renaming unit configured to, in a case where the first determination unit determines that the document of the same name has a plurality of versions, change the document name of the document of the same name, a first registration unit configured to, in the case where the first determination unit determines that the document of the same name has a plurality of versions, after the document name of the document of the same name has been changed with the renaming unit, register the document being requested to be registered, and a second registration unit configured to, in a case where the first determination unit determines that the document of the same name has only one version, overwrite the document being requested to be registered with the document of the same name and register the overwritten document.

According to an exemplary embodiment of the present invention, depending on whether a registered existing document has a plurality of versions, a system being configured to switch an operation of renaming the existing document and of performing document registration and an operation of directly overwriting the existing document and of registering the document is provided. Consequently, it is possible to prevent an existing document having a plurality of stored versions and considered to be important from being overwritten and deleted by a client incapable of performing a document version operation. Further, to an existing document having only one stored version, a direct overwrite processing is performed, and consequently, the storage can be saved.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute apart of the specification, illustrate exemplary embodiments, features, and aspects of the invention and, together with the description, serve to explain the principles of the invention.

FIG. 1 illustrates a system configuration according to a first exemplary embodiment.

FIG. 2 illustrates a hardware configuration of a document management server and personal computers (PCs) to be used by a user according to the first exemplary embodiment.

FIG. 3 illustrates a configuration of the document management server according to the first exemplary embodiment.

FIG. 4 illustrates an example of a screen of a WebDAV client incapable of performing a document version operation.

FIG. 5 illustrates an example of a screen of a client capable of performing the document version operation.

FIG. 6 is an example of a structure of a document information table storing documents and data about versions of the documents.

FIG. 7 illustrates a state of the document information table when backup processing of an existing document is performed and a document of the same name is registered according to the first exemplary embodiment.

FIG. 8 illustrates a state of the document information table when overwrite processing is performed to the existing document according to the first exemplary embodiment.

FIG. 9 is a flowchart illustrating processing performed by the document management server in performing document registration according to the first exemplary embodiment.

FIG. 10 illustrates an example of a structure of a related document table for associating a document to be registered and an existing document of the same name with each other according to a second exemplary embodiment.

FIG. 11 is a flowchart illustrating processing of associating the document to be registered and the existing document of the same name with each other in performing the document registration according to the second exemplary embodiment.

FIG. 12 is an example of a screen displaying a renamed existing document and a registered document associated with each other according to the second exemplary embodiment.

FIG. 13 is an example of a screen displaying, in the property of the registered document, information of the renamed existing document as a related document according to the second exemplary embodiment.

### DESCRIPTION OF THE EMBODIMENTS

Various exemplary embodiments, features, and aspects of the invention will be described in detail below with reference to the drawings. The exemplary embodiments described below are examples of the present invention, and the arrangements are not limited to these exemplary embodiments.

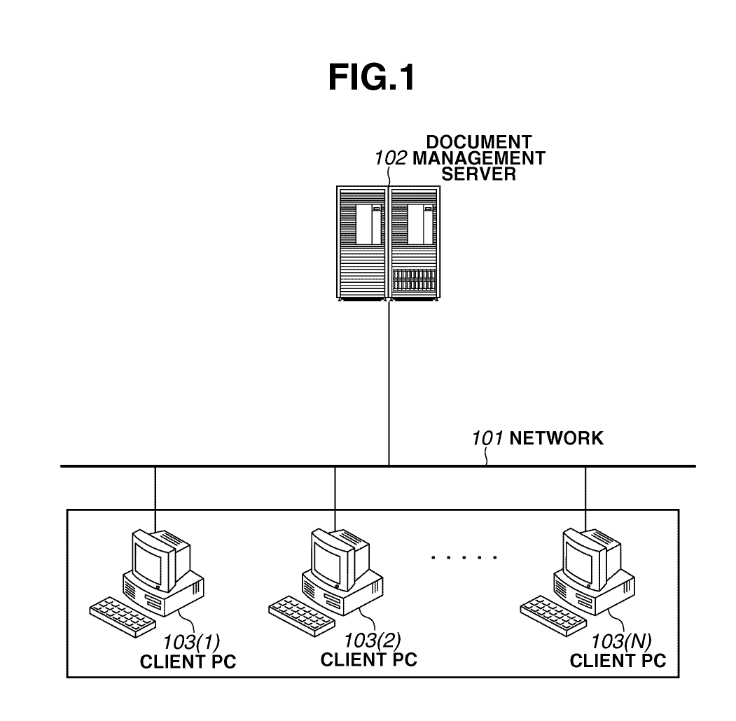

FIG. 1 illustrates a configuration of a document management system (also referred to as a document sharing system) including a document management server (also referred to as a document sharing server) 102 and client PCs 103 according to a first exemplary embodiment of the present invention. In FIG. 1, via a network 101, the document management server 102 and a plurality of client PCs 103(1) to 103(N) are interconnected.

The document management server 102 is an information processing apparatus having a function to communicate with the client PCs 103. The document management server 102 receives a request (processing request) transmitted from the client PC 103 via the network 101, and performs processing corresponding to each processing request.

The client PC 103 is an information processing apparatus (computer apparatus) used by a user (an operator) of the document management system. The client PC 103 serves as a document management client by executing a web browser, a dedicated client application, or a WebDAV client application (hereinafter, referred to as a WebDAV client). According to an operation instruction by the user, a document on the document management server can be operated.

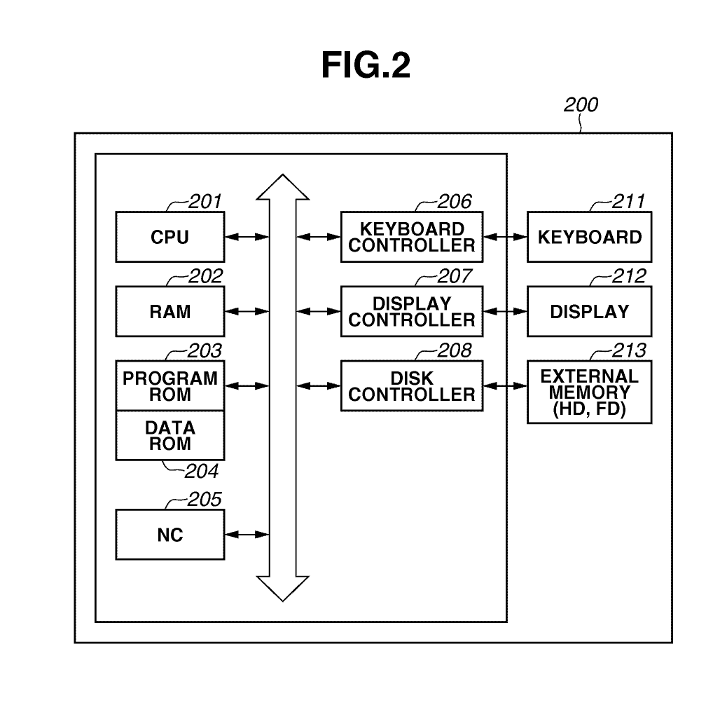

FIG. 2 illustrates a hardware configuration of an information processing apparatus 200 that can function as the document management server 102 or the client PC 103.

A central processing unit (CPU) 201 is a computer that performs calculation and control of the information processing apparatus 200. A random access memory (RAM) 202 serves as a main memory of the CPU 201, and is used as an execution area of an execution program or a data area. An execution program for causing a computer (CPU) to execute the processing in each flowchart described below is read from an external memory 213 described below to the RAM 202, and executed.

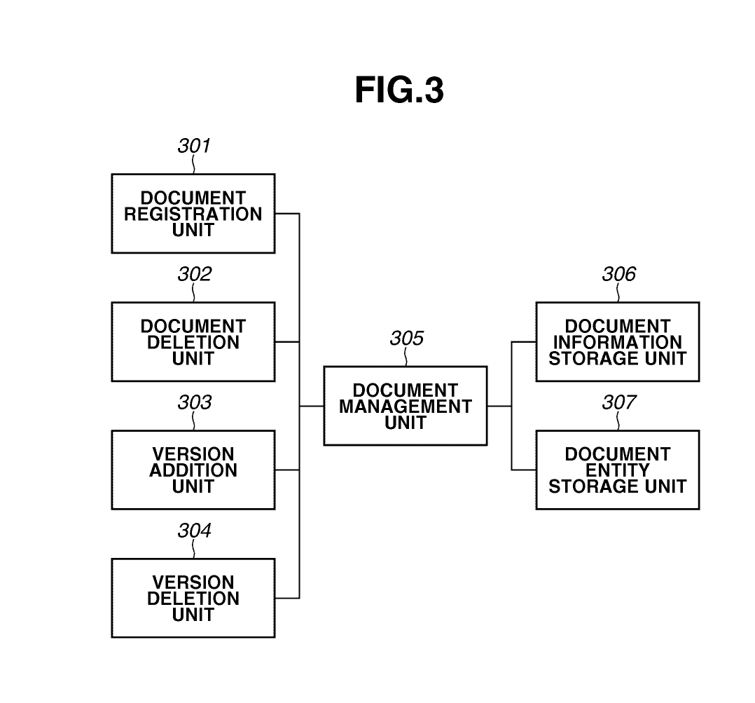

In the document management server 102, a program for causing a computer (CPU) that functions as processing units in FIG. 3 described below for performing requested processing from the client PC 103 is read from an external memory to the RAM 202, and the program is executed.

Ina program ROM 203, basic software (operating system (OS)) of a system program used for device control in the information processing apparatus 200 is recorded. In a data ROM 204, information necessary to provide functions of the information processing apparatus 200, and other information are recorded. For example, in the document management server 102, a document registered from the client PC 103, attribute information of the document, information of the user of the client PC 103, and the like can be recorded in the data ROM 204. In place of the data ROM, an external memory 213 described below can be used.

A network controller (NC) 205 is connected to the network, and performs communication control processing with the other devices connected to the network. A keyboard controller 206 controls a key input from a keyboard 211 described below. A display controller 207 has a function of expanding image data to display information in the information processing apparatus 200 on a screen of a display 212, and controls the display. A disk controller 208 controls input and output of various kinds of data stored in the external memory 213.

The keyboard 211 is an instruction input device for users operating the information processing apparatus 200 to perform an input operation. For example, when the user performs a maintenance work of the document management server 102, the user can operate the keyboard 211 while referring to information displayed on the display 212. The display 212 is, for example, a display device such as a liquid crystal display (LCD). The external memory (a hard disk (HD) or a floppy disk (FD)) 213 is a storage device used to store an application program and various kinds of data.

FIG. 3 illustrates a configuration of the document management server 102 according to the exemplary embodiment. In the exemplary embodiment, a computer (CPU 201) reads a program from a computer-readable storage medium and executes the program to cause the document management server 102 to function as the processing units 301 to 307 in FIG. 3. Apart of the processing can be implemented with hardware (electronic circuit). In the exemplary embodiment, the document management server consists of one information processing apparatus. Alternatively, the document management server can be implemented with a plurality of image processing apparatuses serving as a server.

A document registration unit 301 has a function for registering a document (file) received from the client PC 103 and information about the document in a document information storage unit 306 and a document entity storage unit 307.

A document deletion unit 302 has a function for deleting a document stored in the document information storage unit 306 or the document entity storage unit 307, and information about the document according to a request from the client PC 103.

Aversion addition unit 303 has a function for adding a document (file) received from the client PC 103 to a document that has already been stored in the document information storage unit 306 or the document entity storage unit 307 as a latest version.

A document deletion unit 304 has a function for deleting a version of a document stored in the document information storage unit 306 or the document entity storage unit 307 according to a request from the client PC 103.

A document management unit 305 has a function for managing document entity data and document information stored in the document information storage unit 306 or the document entity storage unit 307 described below according requests from the processing units 301 to 304.

The document information storage unit 306 has a function for storing information (attribute information and the like) about a document by using a file system (or a database system) in the document management server 102.

The document entity storage unit 307 has a function for storing a document entity (entity data of a document) by using a file system (or a database system) in the document management server 102.

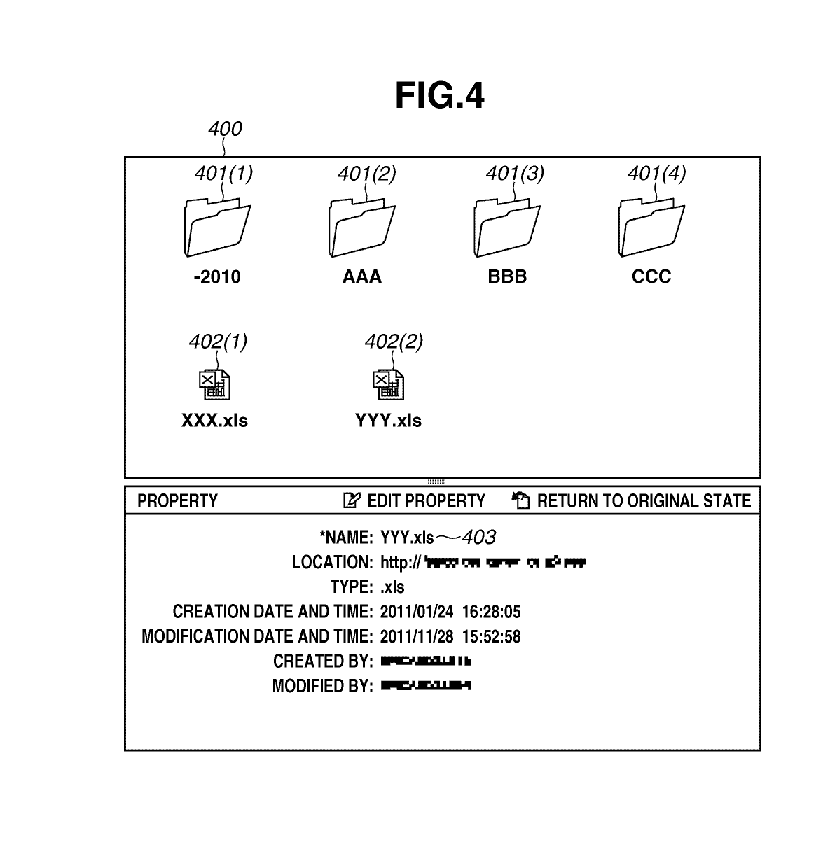

FIG. 4 illustrates a screen 400 displayed when the client PC 103 accesses the document management server 102 with the WebDAV client that cannot perform a document version operation, and displays document information (folders and documents) stored in the document information storage unit 306.

Folders 401 are managed by the document management server 102. The folders 401 can be created in the document management server 102 according to an instruction from the client PC 103. In a general document management system, the user effectively manages documents by creating a hierarchical structure of folders and storing related documents in one folder. In the document management system, a plurality of folders 401(1), 401(2), . . . , and 401(N) can be created.

Folders 402 indicate documents (files) managed by the document management server 102. The documents 402 are documents (files) registered from the client PC 103. In the document management system, a plurality of documents 402(1), 402(2), and . . . can be registered.

A document name 403 indicates a document name set in the document management server 102 out of properties of a document being managed by the document management server 102. As a default document name, the same name as an original document name of a document to be registered is given. The document name can be arbitrarily changed and set based on an instruction from the user of the client PC 103 when the document to be registered is received from the client PC 103.

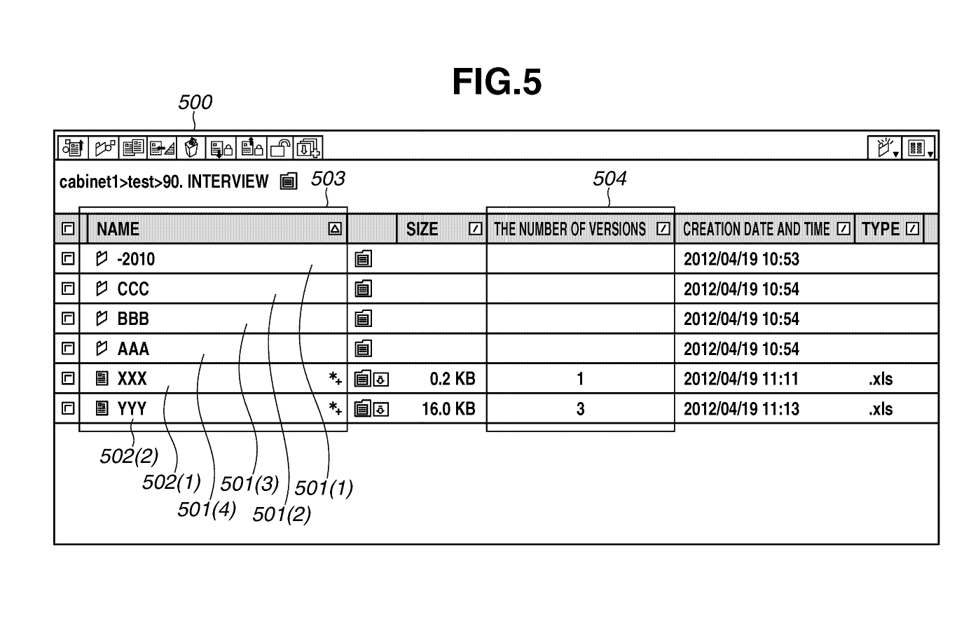

FIG. 5 illustrates a screen 500 displayed when the client PC 103 accesses the document management server 102 by using a client (for example, a dedicated client application) that can perform the document version operation, and displays the same document information (folders and documents) as that in FIG. 4.

The client in FIG. 5 is different from the WebDAV client in FIG. 4, and the client can specify a version of a document and operate the document. Consequently, in FIG. 5, the version information (the number of versions) of each document is also displayed.

Folders 501 are managed by the document management server 102. Documents 502 indicate documents (files) managed by the document management server 102. A document name 503 indicates a document name of a document.

The number of versions 504 indicates the number of versions stored for a document managed by the document management server 102. In other words, a document of the number of versions 2 or more indicates that the document has old versions other than the latest version. In a case where a client capable of operating versions is employed, in addition to the latest version, the client PC 103 can view the document 502 of an old version by specifying and operating the old version.

Clients that can access the document management server 102 include clients capable of performing the document version operation such as the client illustrated in FIG. 5, and clients incapable of performing the document version operation such as the client illustrated in FIG. 4.

The client capable of performing the document version operation illustrated in FIG. 5 can specify a version of an existing document to perform a modification work, and can specify a new version to perform a registration work of the new version.

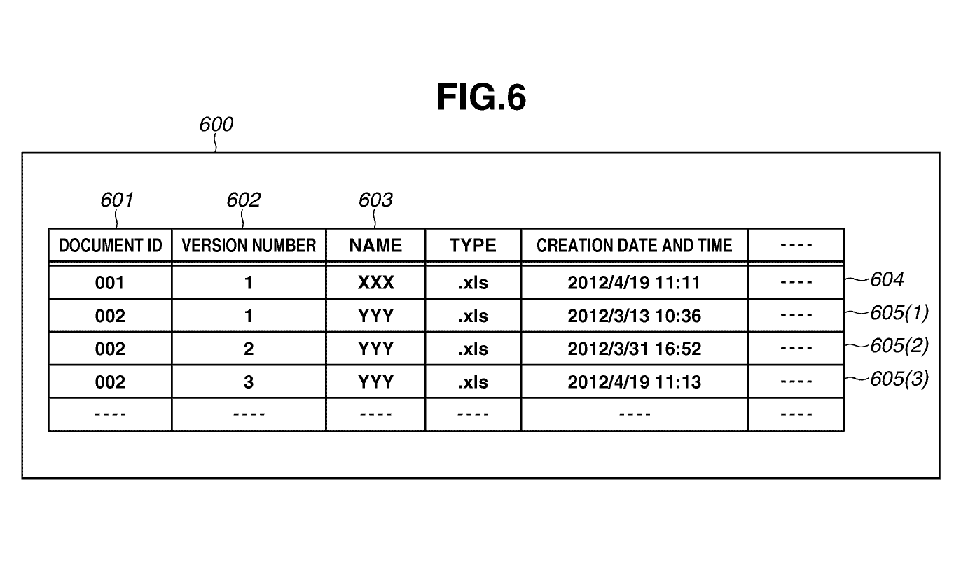

On the other hand, the client incapable of performing the document version operation illustrated in FIG. 4 cannot specify a version of an existing document. In the exemplary embodiment, with reference to FIGS. 6 to 9, processing to be performed when a document registration operation is performed by the client incapable of performing the document version operation is described.

FIG. 6 is a data storage example in a document information table 600 stored in the document information storage unit 306.

The example in FIG. 6 illustrates a state in which document information of the documents 402 (1) and 402 (2) (i.e., the document information of 502 (1) and 502 (2) in FIG. 5) in FIG. 4 is stored. For the sake of simplicity, the table structure illustrated in FIG. 6 is provided, however, in actual operation environments, the table structure and the data items are not limited to the example.

A document ID 601 is an ID (identifier) assigned in the document management server 102 when the client PC 103 registers a new document in the document management server 102. A combination of the document ID 601 and a version number 602 described below provides a unique ID that can be used to identify a version of a document managed in the document management system.

The version number 602 indicates a version of each document. Normally, when a new document is registered in the document management server 102, a version number “1” is assigned, and when a version is added to the existing document (the version 1) that has been registered in the document management server 102, document data is added as a new version number “2”.

For example, when a document of a new version is added to a document 605 (1) described below, a document 605 (2) to which a version number “2” is assigned is added while the document ID 601 is maintained to be “002”. Further, when a document of a new version is added to a document 605 (2), a document 605 (3) to which a version number “3” is assigned is added while the document ID 601 is maintained to be “002”.

A name 603 indicates a document name, and the name is the same as the name 403 displayed in FIG. 4 (or the name 503 displayed in FIG. 5).

Document information 604 is information of a document being registered in the document management server 102, the document corresponding to the document 402 (1) displayed in FIG. 4 and the document 502 (1) displayed in FIG. 5.

Each of the document information 605 (1) to (3) is information corresponding to each of different versions of one document having been registered in the document management server 102, the one document corresponding to the document 402 (2) displayed in FIG. 4 and the document 502 (2) displayed in FIG. 5.

As will be understood from the version number 504 indicating “3” of the document 502 (2) in FIG. 5, the document information of the document 605 includes three versions of 605 (1), 605 (2), and 605 (3). As described above, for one document, a plurality of versions can be created, and for each version, document information is generated. As a result, while the document ID 601 and the name 603 are the same respectively, the data of different version numbers 602 is generated.

It is assumed that, with the document information 604, 605 (1), 605 (2), and 605 (3), document entities of the document of the individual versions are associated.

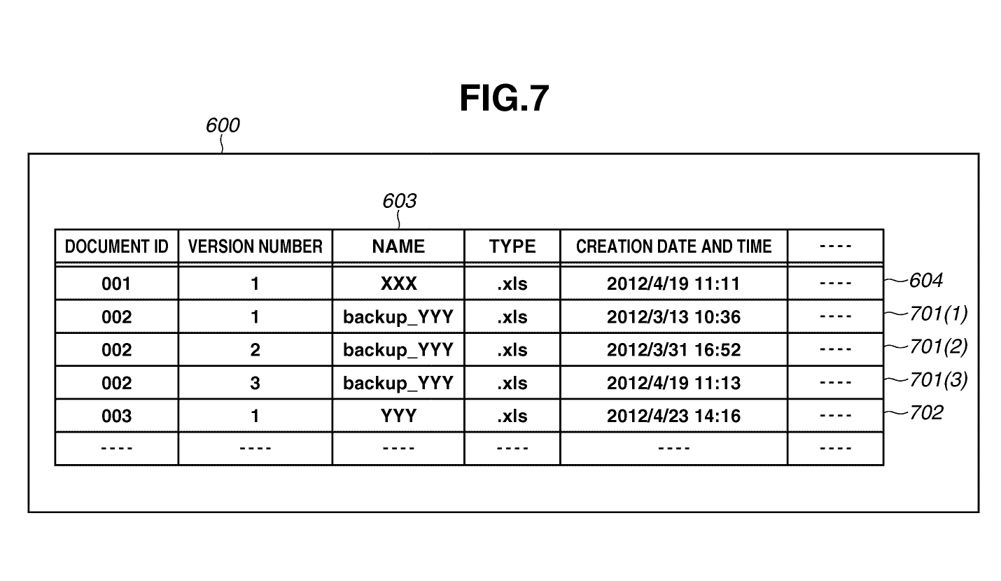

FIG. 7 illustrates changes and additions to the data in the document information table 600 in FIG. 6, in a case where, with the WebDAV client incapable of performing the document version operation, the client PC 103 tries to perform overwrite registration under the same document name to the document 402 (2) storing a plurality of versions in the document management server 102.

In the exemplary embodiment, when the overwrite registration is performed under the same document name, if the number of versions of an existing document is two or more, the existing document is renamed to be stored, and a new document of the same name is registered.

The documents 701 (1), 701 (2), and 701 (3) are the same as the documents 605 (1), 605 (2), and 605 (3) in FIG. 6 respectively. The document names 603 “YYY” of the documents 605 (1), 605 (2), and 605 (3) are, however, renamed by the document management unit 305. In the exemplary embodiment, to each of the documents, a prefix “backup” is added to the document name (file name) as illustrated in the documents 701 (1), 701 (2), and 701 (3), and the documents are renamed as “backup_YYY”.

For the sake of simplicity, the prefix to be added to a document name is “backup_”. Alternatively, depending on an actual operation environment, the prefix is not limited to the example, and if users can recognize that the name has been renamed, methods other than the prefix can be employed.

Document information 702 indicates document information of a document to which the client PC 103 tries to perform the overwrite registration with the WebDAV client incapable of performing the document version operation, and the information indicates that a document of the document name “YYY” has been registered.

In other words, with the WebDAV client incapable of performing the document version operation, if the client PC 103 tries to perform the registration (overwrite registration) of a document of the same document name to the document 402 (2) having the plurality of versions, first, at the document management server 102 side, the existing document 402 (2) is automatically renamed, and then the document management server 102 registers the document under the same name. The arrangement enables the document management server 102 to recognize that the existing document having a plurality of stored versions is an important document, and to prevent deletion of the existing document by overwriting.

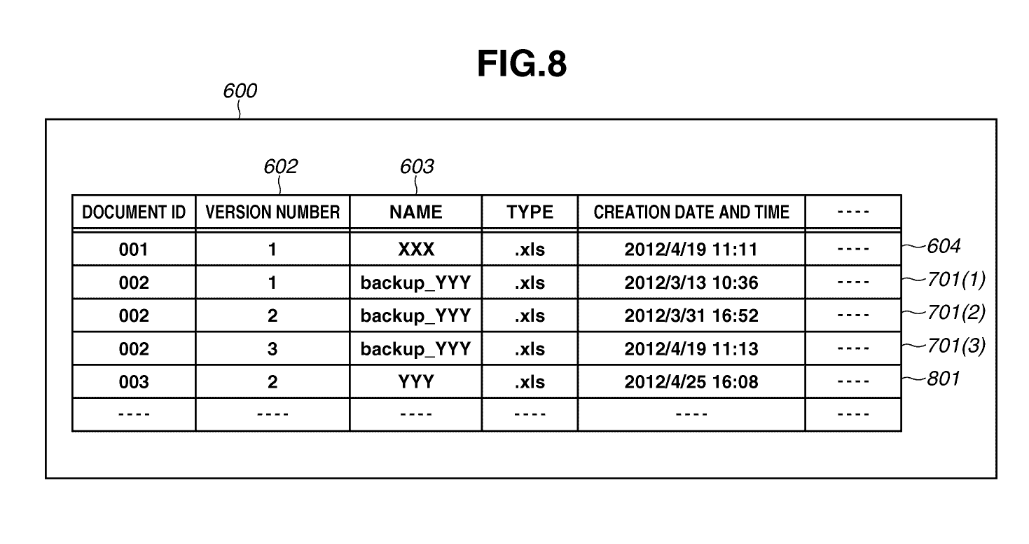

FIG. 8 illustrates changes of the data to the document information table 600 in FIG. 7 in a case where, with the WebDAV client incapable of performing the document version operation, the client PC 103 further performs the overwrite registration under the same document name to the document 702 registered in FIG. 7.

In the exemplary embodiment, when the overwrite registration is performed under the same document name, if the number of versions is one, the document entity of the existing document is deleted and a new document of the same name is overwritten and registered.

A document 801 in FIG. 8 indicates document information of the document to which the overwrite registration has been performed with the WebDAV client incapable of performing the document version operation, and the information indicates that a document of the document name “YYY” has been registered. In the processing, the document entity of the originally registered document 702 in FIG. 7 is deleted, and the document is overwritten with the document 801 newly registered from the client PC 103.

In the exemplary embodiment, the system is configured to perform the operation such that a value of the version number 602 is incremented by the overwriting operation to register the document as the version number “2”, however, the operation is not limited to the example. In other words, with the WebDAV client incapable of performing the document version operation, if the client PC 103 tries to perform the registration (overwrite registration) of a document under the same document name to the existing document 702 having one version, at the document management server 102 side, the existing document 702 is deleted, and document management server 102 performs the overwrite registration to the document 801 under the same name.

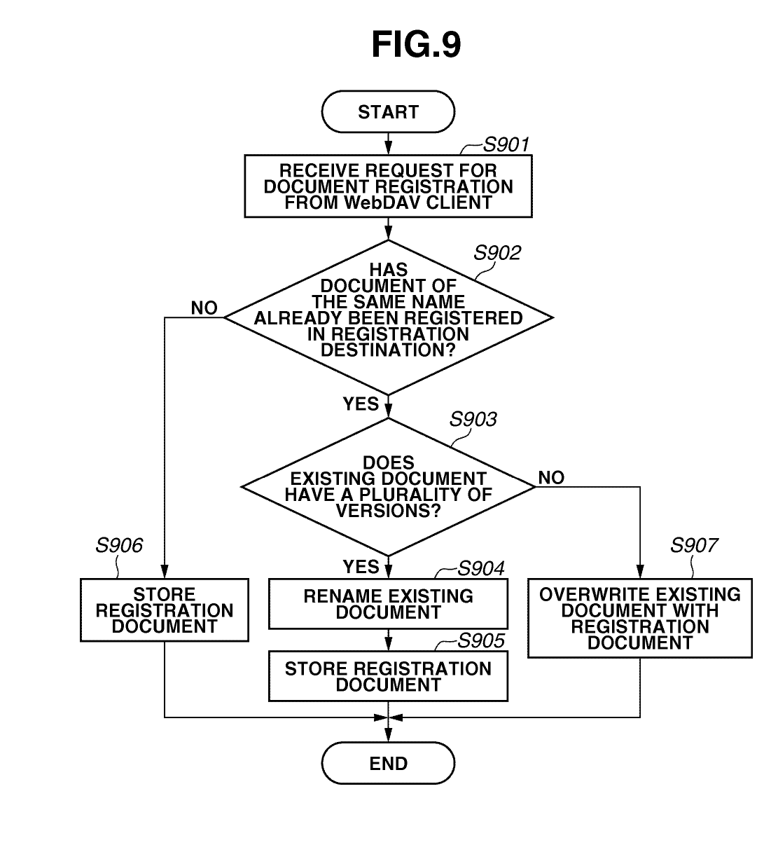

FIG. 9 is a flowchart illustrating processing executed at the document management server 102 side when the client PC 103 tries to perform a document registration with the WebDAV client incapable of performing the document version operation.

In step S901, the document management server 102 receives a document registration request issued from the WebDAV client incapable of performing the document version operation and the file of the document from the client PC 103.

In step S902, the document management server 102 determines whether a document having the same document name 603 has already been registered in a registration destination (i.e., whether the document management server 102 has already been managing a document of the same name). If the document management server 102 determines that a document of the same name has been registered in the document management server 102 (YES in step S902), the processing proceeds to step S903. If a document of the same name has not registered (NO in step S902), the processing proceeds to step S906.

In step S903, the document management server 102 determines whether the document of the same name has a plurality of versions. If the document management server 102 determines that the existing document of the same name in the registration destination has a plurality of versions (YES in step S903), the processing proceeds to step S904. If document management server 102 determines that the document does not have a plurality of versions (NO in step S903), the processing proceeds to step S907.

In step S904, the document management server 102 renames each of the existing documents of the plurality of versions respectively (i.e., changes the document names of the existing documents of the same name).

As described above, in a case where the existing document 605 having the plurality of versions (1 to 3) in FIG. 6 has the same name as that of the document being requested to be registered, the document name “YYY” of the document 605 is to be renamed like the document name “backup_YYY” of the documents 701 (1) to (3) in FIG. 7. In the exemplary embodiment, to the document name of the existing document, a predetermined prefix (in the above example, “backup_”) is added to rename, however, the method is not limited to the example. For example, the document name can be renamed by adding a predetermined postfix.

In step S905, the document management server 102 newly registers the document being requested to be registered from the WebDAV client under the document name of “YYY”.

In step S906, since there is no existing document of the same name, the document management server 102 directly registers the document being requested to be registered from the WebDAV client.

In step S907, the document management server 102 overwrites the existing document (the document of only one version) of the same name with the document being requested to be registered. As described above, if the document 702 not having a plurality of versions illustrated in FIG. 7 is the document having the same document name as the document being requested to be registered, the document management server 102 deletes the document information 702 and the entity data of the document, and performs the overwrite registration under the document name of “YYY”. In the processing, only the version number 602 is incremented from “1” to “2”.

By the above-described processing, using the WebDAV client incapable of performing the document version operation, when the document management server 102 performs the overwrite processing to the document of the same name in the document management server 102, the document management server 102 determines whether the document has a plurality of stored versions.

The document management server 102 determines that the importance of the existing document having stored versions is high, and prevents the existing document from being renamed and overwritten. If the existing document does not have a plurality of versions, the document management server 102 determines that the importance of the existing document is low, and to save the storage capacity of the storage, the existing document is deleted by overwriting it.

In the first exemplary embodiment, the descriptions have been made as to the operations of the document management server performed when the overwrite registration is performed with the same name as that of an existing document in the document management server 102 using the WebDAV client incapable of specifying a version of a document to operate the document. In other words, if an existing document has a plurality of versions, rename processing is performed to the existing document, and if the existing document has only one version, the rename processing is not performed to the existing document and the overwrite processing is performed.

Meanwhile, in the rename processing performed to the document having the same name as that of the existing document, the user is required to check the document name to determine whether the renamed existing document and a document to be newly registered by the WebDAV client are related to each other.

Consequently, in a second exemplary embodiment, a system being configured such that the user of the client PC 103 can easily understand whether the existing document to be renamed is related to the document to be newly registered by the WebDAV client is described.

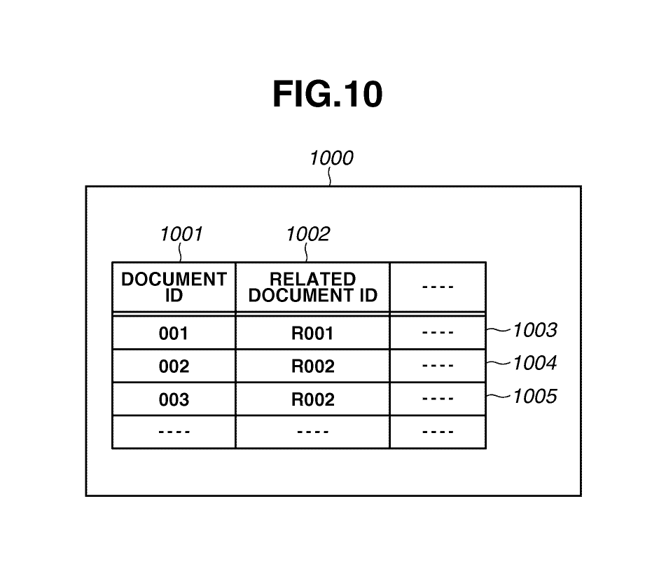

FIG. 10 illustrates a data storage example of a related document table 1000 managed by the document information storage unit 306 according to the exemplary embodiment. Information indicating that the documents 701 (1) to (3) and the document 702 in FIG. 7 are related documents is stored. For the sake of simplicity, such a table structure is provided, however, in actual operation environments, other table structures can be employed.

A document ID 1001 is an item corresponding to the document ID 601 in FIG. 6 (FIG. 7), and in this table, the document ID 1001 is used as an identifier for identifying each document.

In the related document ID1002, a document ID of another document to be related to the document ID1001 is stored to enable association of the documents with each other as related documents.

Data 1003 corresponds to the document (the document 604 in FIG. 7) having the document ID of “001”, and its related document ID is “R001”. In the example illustrated in FIG. 10, there is no other document having the same related document ID, and consequently, no related document exists.

Data 1004 corresponds to the documents (the documents 701 (1) to (3) in FIG. 7) of the document ID of “002”, and its related document ID is “R002”. FIG. 7 shows that the documents 701 has three versions of 701 (1), 701 (2), and 701 (3). The versions are handled as one document, and consequently, regardless of the number of the versions, as the data corresponding to the documents 701, only one document is registered in the table.

Data 1005 corresponds to the document (the document 702 in FIG. 7) of the document ID of “003”, and its related document ID is “R002”. The related document ID “R002” enables the user to determine that the document is a related document of the document of the data 1004.

The system is configured to perform control such that, in the related document table 1000, when an existing document is renamed in the processing in steps S904 and S905 in FIG. 9 described above, and its overwritten document is registered in the document management server 102, the same related document ID is registered and associated as related documents.

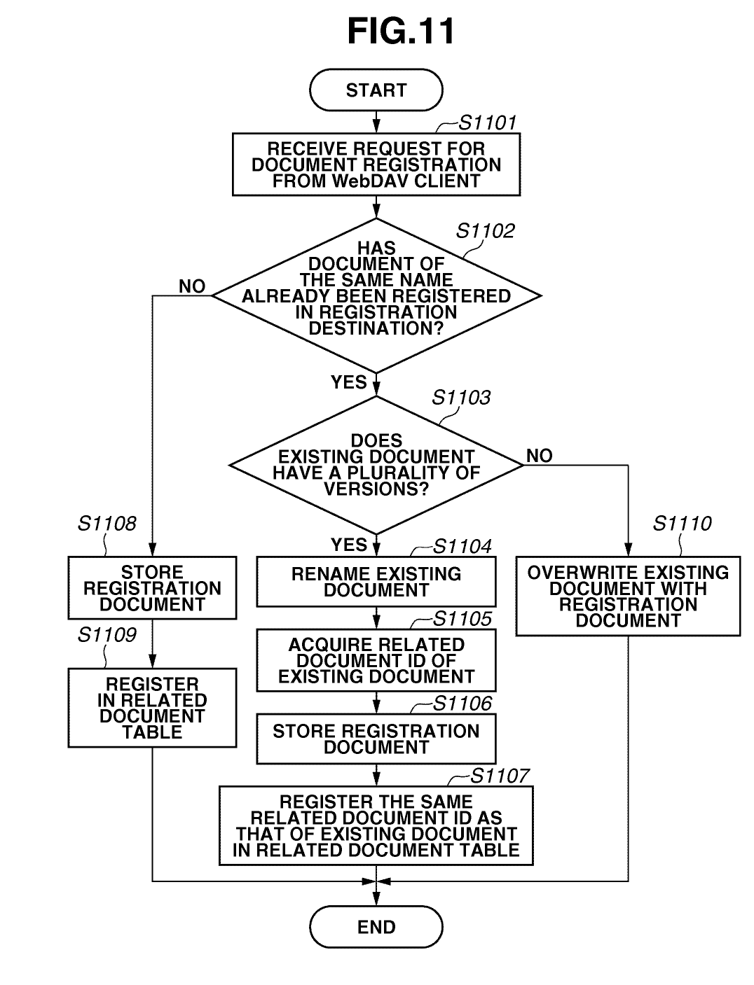

FIG. 11 illustrates a flow of processing for associating an existing document to be renamed with a document to be newly registered as related documents when the client PC 103 performs document registration with the WebDAV client incapable of performing the document version operation.

In step S1101, the document management server 102 receives a document registration request issued from the WebDAV client incapable of performing the document version operation and the file of the document from the client PC 103.

In step S1102, the document management server 102 determines whether a document having the same document name 603 has already been registered in a registration destination. If the document management server 102 determines that a document of the same name has been registered in the document management server 102 (YES in step S1102), the processing proceeds to step S1103. If a document of the same name has not registered (NO in step S1102), the processing proceeds to step S1108.

In step S1103, the document management server 102 determines whether the document of the same name has a plurality of versions. If the document management server 102 determines that the existing document of the same name in the registration destination has a plurality of versions (YES in step S1103), the processing proceeds to step S1104. If the document management server 102 determines that the document does not have a plurality of versions (NO in step S1103), the processing proceeds to step S1110.

In step S1104, the document management server 102 renames each of the existing documents of the plurality of versions respectively. As described above, in the case where the existing document 605 having the plurality of versions (1) to (3) in FIG. 6 has the same name as that of the document being requested to be registered, the document name “YYY” of the document 605 is to be renamed like the document name “backup_YYY” of the documents 701 in FIG. 7.

In step S1105, the document management server 102, from the related document table 1000 in FIG. 10, acquires the related document ID assigned to the documents rename-processed in step S1104.

In step S1106, the document management server 102 registers the document being requested to be registered from the WebDAV client under the document name of “YYY”.

In step S1107, the document management server 102, in the related document table 1000 in FIG. 10, registers the document ID of the document being requested to be registered from the WebDAV client, and associates the related document ID acquired in step S1105 with the data and registers the associated data. By the processing, the data 1004 and the data 1005 in FIG. 10 are associated with each other as related documents.

In step S1108, since there is no existing document of the same name, the document management server 102 directly registers the document being requested to be registered from the WebDAV client.

In step S1109, in response to the completion of the document registration in step S1108, in the related document table 1000 in FIG. 10, the document management server 102 newly generates the document ID of the document registered in step S1108 and the related document ID, and registers the IDs.

In step S1110, the document management server 102 overwrites the existing document (the document of only one version) of the same name with the document being requested to be registered. As described above, the document 702 not having a plurality of versions illustrated in FIG. 7 is the document having the same name as that of the document being requested to be registered, the document management server 102 deletes the document information 702 and the entity data of the document, and performs the overwrite registration under the document name of “YYY”. In the processing, only the version number 602 is incremented from “1” to “2”.

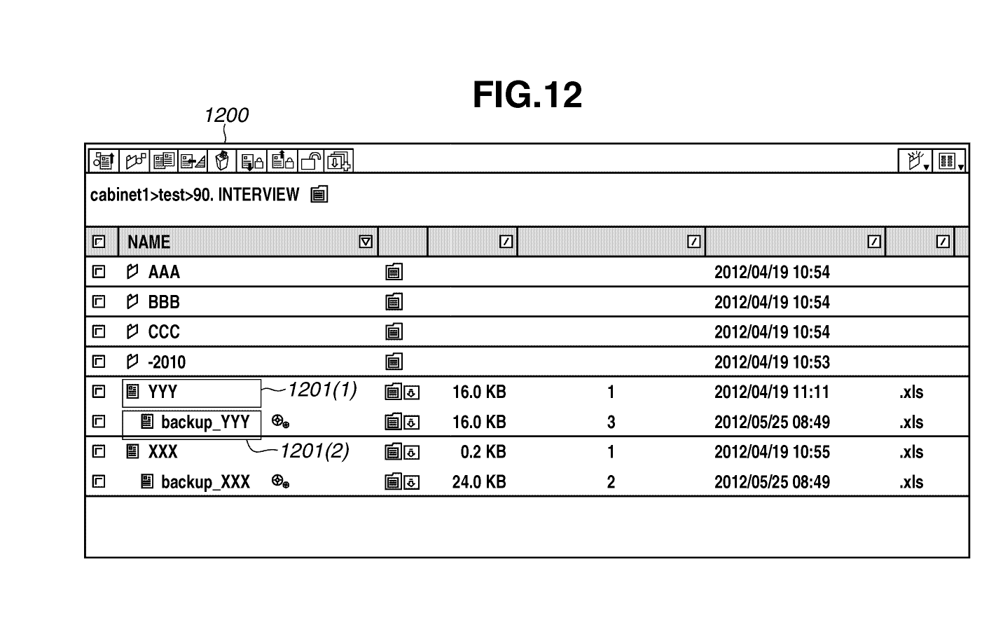

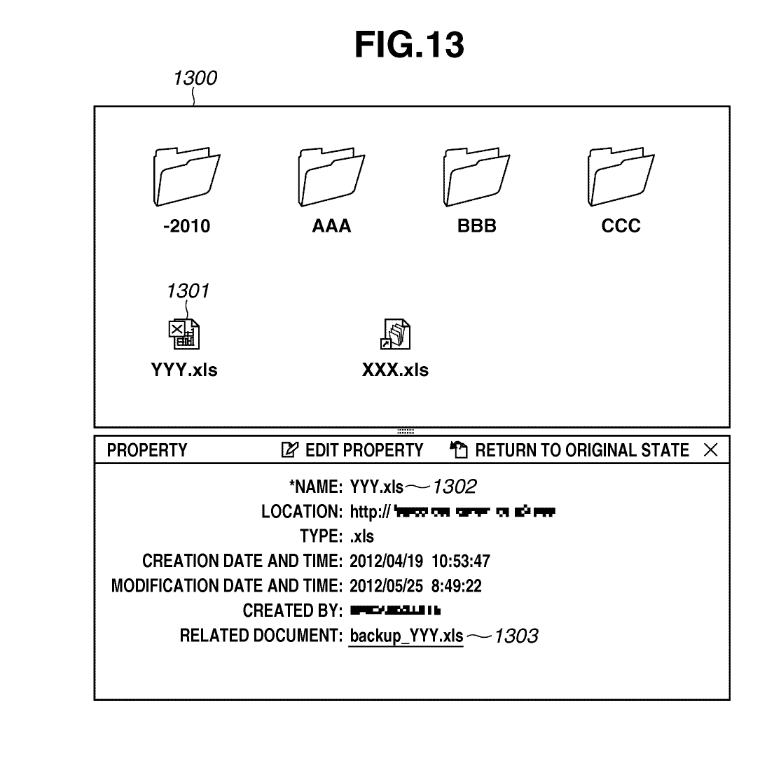

With reference to FIG. 12 and FIG. 13, display screens displaying results of the association of the renamed existing document and the document being requested to be registered and the storage of the documents when the documents is registered using the WebDAV client incapable of performing the document version operation described above will be described.

FIG. 12 illustrates a screen example 1200 displaying documents having been registered in the document management server and renamed documents by another client PC with a client capable of performing the document version operation.

The display of documents 1201 (1) and 1201 (2) enables the user to recognize that the documents (the document IDs “003” and “002”) to which the same related document ID “R002” is assigned in the related document table 1000 in FIG. 10 are related documents by displaying the documents as a group on the screen.

The association and display of the documents to which the same related document ID is assigned in the related document table 1000 in FIG. 10 enables the user to easily recognize that the documents are related on the screen.

FIG. 13 illustrates a screen example 1300 displaying documents having been registered in the document management server and renamed documents with a client incapable of performing the document version operation.

A document 1301 is a document having been registered as a document of the same name. When the user displays the property of the document 1301, the document name requested to be registered from the client PC is displayed in a name 1302.

The document management server, based on the information in the related document table in FIG. 10, describes the information (for example, link information) of the related document in the property of the document 1301, and transmits the data to the WebDAV client to display the information. In other words, like information 1303, the document name of the renamed existing document is displayed in the property.

To hierarchically representing the relationship between the documents on a screen such as the screen in FIG. 12, although functional implementation is required at the client side, the information of the related document is described in the property of the document as illustrated in FIG. 13, and thereby, the representation can be achieved by providing only the functional implementation at the document management server side. Consequently, even if the WebDAV client incapable of performing the document version operation is employed, information of a related document can be easily checked by viewing the property of a document.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment (s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2012-124832 filed May 31, 2012, which is hereby incorporated by reference herein in its entirety.

What is claimed is:

1. A document management server having a document version management function, the document management server comprising:
a reception unit configured to receive a registration request of a document from a client;
a first determination unit configured to, in a case where a document of the same name as that of the document being requested to be registered has been registered, determine whether the document of the same name has a plurality of versions;
a renaming unit configured to, in a case where the first determination unit determines that the document of the same name has a plurality of versions, change a document name of the document of the same name;
a first registration unit configured to, in the case where the first determination unit determines that the document of the same name has a plurality of versions, after the document name of the document of the same name has been changed by the renaming unit, register the document being requested to be registered; and
a second registration unit configured to, in a case where the first determination unit determines that the document of the same name has only one version, overwrite the document being requested to be registered with the document of the same name and register the overwritten document.

2. The document management server according to claim 1, wherein, with respect to a document managed by the document management server, the client is incapable of specifying a version to operate the document.

3. The document management server according to claim 2, wherein the client is a WebDAV client.

4. The document management server according to claim 1, further comprising:
a second determination unit configured to determine whether a document of the same name as that of the document being requested to be registered has been registered; and
a third registration unit configured to, in a case where the second determination unit determines that a document of the same name as that of the document being requested to be registered has not registered, newly register the document being requested to be registered,
wherein, the first determination unit, in a case where the second determination unit determines that a document of the same name as that of the document being requested to be registered has been registered, determines whether the document of the same name has a plurality of versions.

5. The document management server according to claim 1, wherein the renaming unit, to the document name of the same name, adds a predetermined prefix or a predetermined postfix to change the document name of the document of the same name.

6. The document management server according to claim 1, further comprising:
a relevant information registration unit configured to register information for associating the document renamed by the renaming unit with the document registered by the first registration unit in a case where the first determination unit determines that the document of the same name has a plurality of versions.

7. A document management method to be executed by a document management server having a document version management function, the document management method comprising:
receiving a registration request of a document from a client;
in a case where a document of the same name as that of the document being requested to be registered has been registered, determining whether the document of the same name has a plurality of versions;
in a case where it is determined that the document of the same name has a plurality of versions, renaming a document name of the document of the same name;
in the case where it is determined that the document of the same name has a plurality of versions, after the document name of the document of the same name has been changed, registering the document being requested to be registered; and
in a case where it is determined that the document of the same name has only one version, overwriting the document being requested to be registered with the document of the same name, and registering the overwritten document.

8. The document management method according to claim 7, wherein the renaming is performed by, to the document name of the same name, adding a predetermined prefix or a predetermined postfix to change the document name of the document of the same name.

9. A non-transitory computer-readable storage medium storing a program for causing a computer to execute the method according to claim 7.
